(19) United States
(12) Patent Application Publication
(10) Pub. No.: US 2021/0032857 A1
(43) Pub. Date: Feb. 4, 2021

(54) A Building

(71) Applicant: Charles Caulder Bree, Mercer (NZ)

(72) Inventor: Charles Caulder Bree, Mercer (NZ)

(73) Assignee: Charles Caulder Bree, Mercer (NZ)

(21) Appl. No.: 17/044,940

(22) PCT Filed: Mar. 26, 2019
(86) PCT No.: PCT/NZ2019/050031

§ 371 Date: Oct. 2, 2020

(30) Foreign Application Priority Data
Apr. 3, 2018 (NZ) 741282

(51) Int. Cl. E04B 1/35; E04B 1/16; E04B 1/32; B29C 41/08; B29C 44/12; B28B 1/32

(52) U.S. Cl. CPC E04B 1/3505; E04B 1/166; E04B 1/3205; E04B 1/34336; B29C 44/12; B28B 1/32; B29C 41/08

(57) ABSTRACT

A method for forming a building includes obtaining a mould, spraying a first spray material onto the outside of the mould so that it sets generally in the shape of the mould to provide a core. The core has side walls, and end wall integral with the side walls and a roof integral with both the side walls and end wall. A second spray material different to the first spray material is sprayed onto the inner and outer surfaces of the core to give it a rigid skin.

### FIELD OF THE INVENTION

This invention relates to building formed through spraying a suitable material onto a mould. A preferred embodiment of the invention relates to such a building when formed to be readily transportable.

### BACKGROUND

There is a problem in many parts of the world when it comes to meeting demand for buildings that can be produced quickly and economically, and then conveniently transported to the site of need. Such buildings may for example be required for short or long-term accommodation, event offices, storage of items, recreational purposes or other uses.

### OBJECT OF THE INVENTION

It is an object of preferred embodiments of the invention to go at least some way towards addressing the above problem. While this applies to preferred embodiments, it should be understood that the object of the invention per se is not so limited and is simply to provide a useful choice. Therefore any objects or benefits applicable to preferred embodiments should not be read as a limitation on claims expressed more broadly.

### Definitions

The term “comprising” if and when used in this document in relation to a combination of features does not rule out the option of there being further unnamed features. The term is therefore inclusive, not exclusive.

### SUMMARY OF THE INVENTION

In one aspect the invention there is provided a method of forming a building, comprising the steps of:
obtaining a rigid mould comprising an end wall, a pair of side walls and an open front;
spraying a first spray material onto the outside of the mould so that it sets generally in the shape of the mould to provide a core having at least:
   side walls;
   an end wall integral with the side walls; and
   a roof integral with both the side walls and end wall; and
spraying a second spray material different to the first spray material and comprising polyurea onto the inner and outer surfaces of the core to give it a rigid structural skin.

Optionally the first spray material sets on the mould as a rigid foam.

Optionally the core is 50 mm to 110 mm thick.

Optionally the core is 70 mm to 100 mm thick.

Optionally the core is approximately 80 mm thick.

Optionally the skin is 1 mm to 10 mm thick.

Optionally the skin is 3 mm to 8 mm thick.

Optionally the skin is no more than 6 mm thick.

Optionally the skin is about 3 mm thick.

Optionally the core comprises polyurethane.

Optionally the core comprises polyurethane foam insulation (Endurathane SR42M)¹, for example as supplied by Polymer Group Ltd, of Auckland New Zealand. ¹https://www.polymer.co.nz/wp-content/uploads/2015/03/Endurathane-SR42M-Rev4.pdf

Optionally the skin comprises polyurea.

Optionally the skin comprises polyurea spray lining, (Endurathane P-515)², for example as also supplied by Polymer Group Ltd. ²https://www.polymer.co.nz/wp-content/uploads/2017/11/Endurathane-P-515-Rev1.pdf

Optionally the side walls and roof together give the building an arch shape in transverse cross-section.

Optionally a further end wall is combined with the side walls at an opposite end to form an enclosed area, this further end wall having a doorway.

Optionally the side walls and the end walls are secured to a floor (for example on a ledge forming part of the floor).

Optionally the side walls are securely fixed to the second mentioned end wall by spraying a suitable spray material (eg polyurea) where they meet.

Optionally the side walls and end walls are securely fixed to a floor by spraying a suitable spray material (eg the same material used for the skin) where they meet the floor.

Optionally the mould on which the core is sprayed is metallic, for example steel.

### IMAGES

Some preferred embodiments of the invention will now be described by way of example and with reference to the accompanying images, of which:

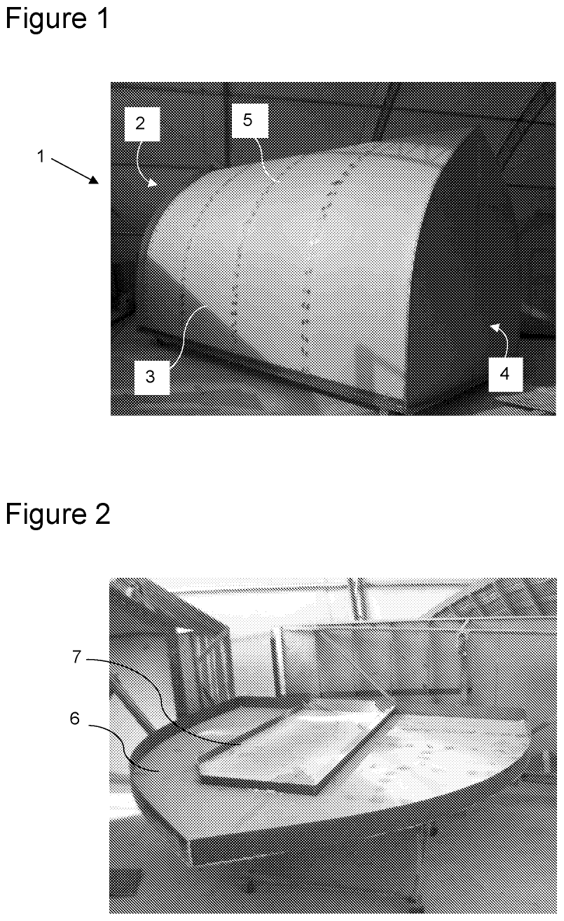

FIG. 1 is an isometric view of a mould for use in forming the end wall, side walls and roof of a building;

FIG. 2 is an isometric view of a mould for forming a front wall of the building;

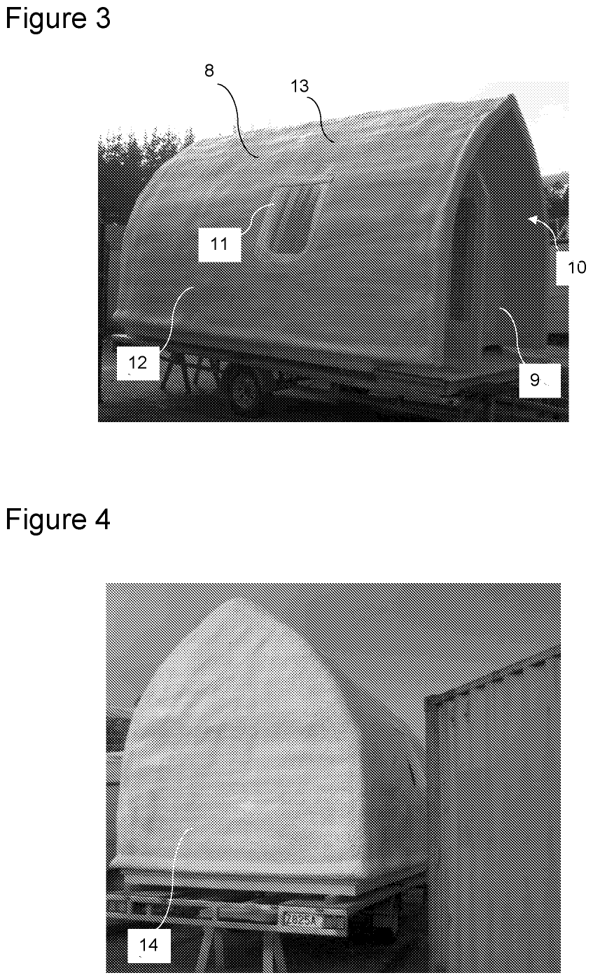

FIG. 3 is a side isometric view of the building;

FIG. 4 is an isometric view of the building from its back end;

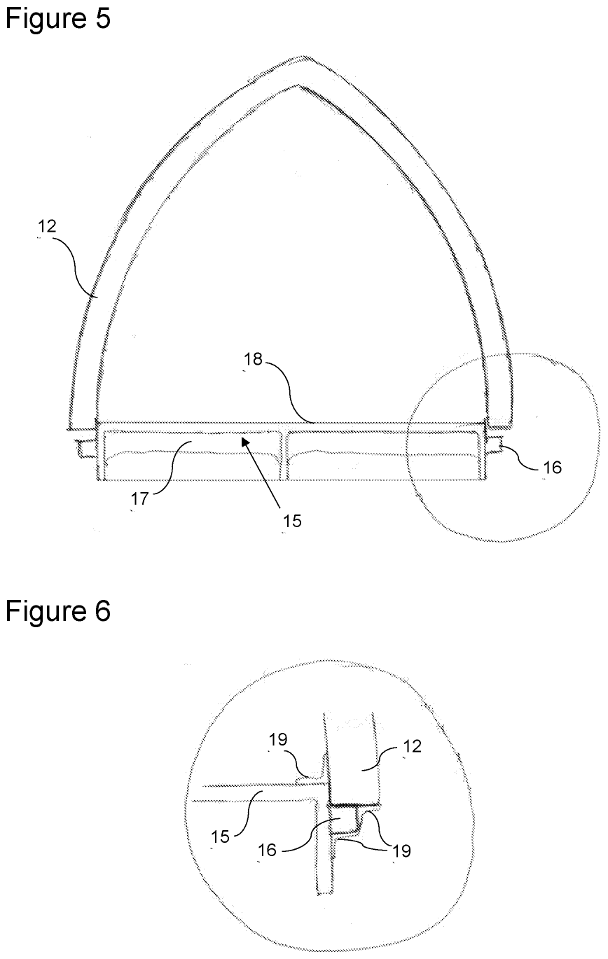

FIG. 5 is a transverse cross-sectional view of the building;

FIG. 6 is a transverse cross-sectional view showing detail of the part circled in FIG. 5, indicating how the buildings walls and floor engage one another;

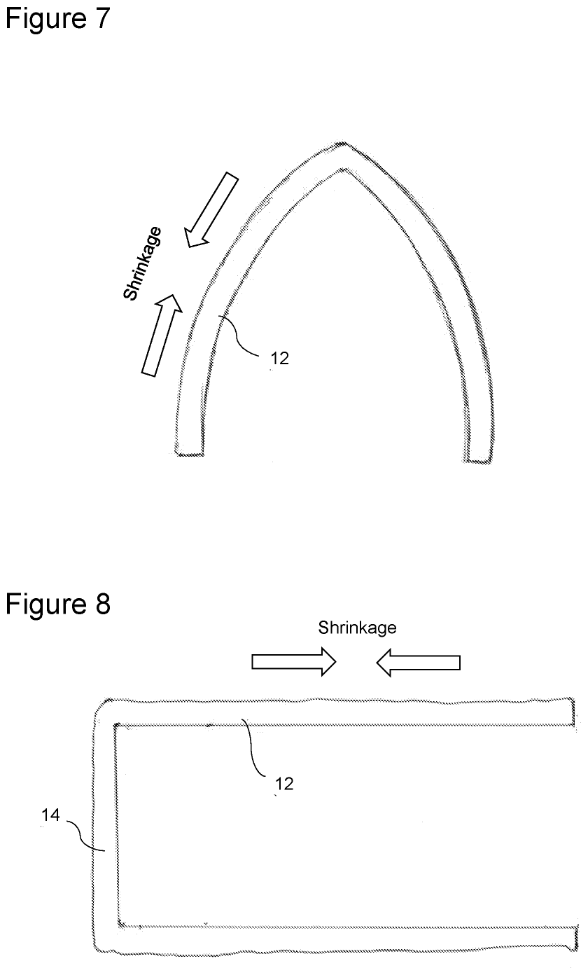

FIG. 7 is a part transverse cross-sectional view of the side walls illustrating the direction of shrinkage thereof;

FIG. 8 is a part longitudinal cross-sectional view of the side walls further illustrating the direction of shrinkage thereof; and

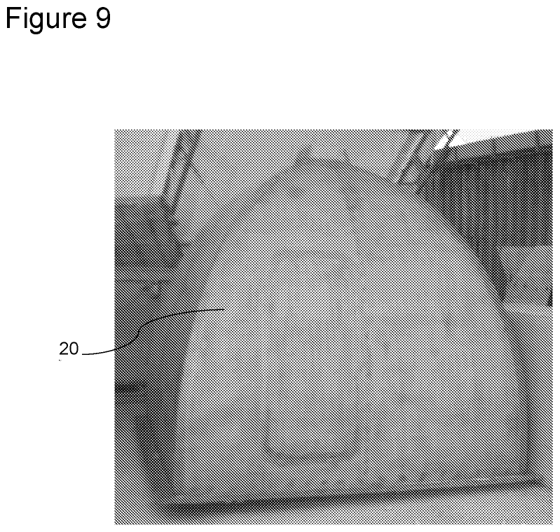

FIG. 9 is an isometric view of a mould for use in forming at least the end wall, side walls and roof of a building according to a further embodiment of the invention.

### DETAILED DESCRIPTION

Referring to FIG. 1, a steel mould 1 is provided generally in the shape of the building to be formed. It has an end wall 2, a pair of side walls 3 and an open front 4. Each sidewall 3 merges into an arched roof 5. Preferably the mould 1 is formed from steel or some other metallic or composite material (eg fiberglass) and a spray-release gel is applied to its exterior.

A spray gun is used to spray polyurethane foam-forming material over only the outside of the mould; therefore over the end wall, side walls and roof. Preferably material is polyurethane foam insulation known as Endurathane SR42M as referenced above. However other suitable polyurethane materials may be substituted. When the sprayed material sets, it provides a rigid polyurethane foam structural core for the building. It can be sprayed to whatever thickness is suitable for the building's end-use. If the building is intended for cold climates then the core is sprayed to a greater thickness than would be the case for warm climates. In a preferred embodiment for use in moderate climates, the foam core has a density of 30-40 kg/m³ and a thickness of 70-90 mm. Most preferably the density is approximately 35 kg/m³ and the thickness is approximately 80 mm.

When the foam core has set it is removed from the mould 1. Release from the mould 1 is assisted by the fact that as the foam sets it shrinks slightly, for example about 1%, in the longitudinal and vertical directions. The core is then sprayed inside and out with a suitable polyurea material to give it a rigid structural skin on both sides. The skin can be sprayed to a thickness appropriate for the intended use for the building. Preferably the skin is less than 6 mm thick on each side, and most preferably 1-3 mm thick. Preferably the material used for the skin is polyurea spray lining known as Endurathane P-515, although other suitable materials may be substituted. Endurathane P-515 comprises isocyanate and polyol.

Referring to FIG. 2, a frontend wall for the building is formed separately. This is achieved by first taking a metallic dish-like wall mould 6 and spray-filling it with the same foam-forming material mentioned for the core, to about the same thickness. When this partially formed frontend wall has set it is removed from the mould 6 and sprayed on both sides with same polyurea material as the core, to give the frontend wall a rigid structural skin of the same thickness.

As shown in FIG. 2, to give the frontend wall a door opening a door frame 7 is placed into the mould 6 before it is spray-filled. The door frame may be wooden, steel or some other metallic or composite material (eg fiberglass). As will be appreciated, to create the opening, the area within the frame 7 is not spray-filled. Preferably the frame 7 is left in place and the skin is sprayed over it so that the frame becomes part of the wall. The polyurethane foam is such that it bonds to the frame 7, and particularly when wooden it provides convenient points for hinge attaching a swing door and installing a lock.

FIGS. 3 and 4 illustrate the exterior of the finished building 8. As per FIG. 3, the frontend wall 9 that was formed by way of the mould 6 is set back from the leading edge of the side walls 12 and roof 13, so as to provide a measure of weather protection around the doorway 10. As also shown, the building has a window 11 formed by cutting a space in the side wall 12. In that case the appropriate window shape is cut out from the foam core and all its surfaces sprayed with polyurea to tie the inside of the side wall to the outside of the side wall. Alternatively, the window can be formed by adding a window frame to the mould 1 and spraying the polyurethane foam around it. The window 11 has a flexible acrylic or polycarbonate cover sheet pivotally attached at the top of the window's frame so that it can be opened by swinging the cover upwards. The building's rear-end wall 14 is shown in FIG. 4.

In all preferred forms of the invention the entire structural rigidity and insulation of the side, rear-end and front-end walls, and the roof, is provided by the polyurethane foam and the polyurea skin. There is no need for internal or external reinforcing.

As shown in FIGS. 3 and 4, the exterior of the building has a rustic appearance given that the outside of the core was not against the mould 1 when formed. This means that only the inside of the core, ie the side that was against the mould 1 when formed, has a smooth finish. As the sprayed-on skin is only 1-3 mm thick it does not conceal the outside undulations or imperfections in the outside of the core. However, if a building with a smooth exterior is desired, then the work-person spraying the core on the mould 1 can simply adjust the spray technique to achieve the desired result.

The frontend wall 9 extends virtually the entire distance between the building's side walls 12 and is connected to them by spraying the same polyurea along the joins. The polyurea creates a strong watertight connection between the frontend and side walls 9, 12. In some embodiments the connection is made before spraying the skin on core, and in other embodiments it is made after the skin has been sprayed on the core.

Referring to FIG. 5, a pre-formed floor 15 is added between the frontend, side and rear-end walls 9, 12, 14. In this regard each side wall 12 sits snugly on a step or ledge 16 in the sides of the floor. The rear-end wall 14 sits on a similar ledge in the end of the floor. The frontend wall 9 can also sit on a similar ledge or, as in the embodiment illustrated, can sit on the upper face of the floor (not on a ledge).

The floor 15 can be formed by spray filling a suitably shaped mould with the same polyurethane foam. In this regard the foam 17 may be sprayed onto a plywood 18 or other wooden surface until the desired thickness is achieved, and then inverted so that the plywood becomes the walk-on surface inside the building.

FIG. 6 illustrates the manner in which the rear-end and side walls 9, 12 are structurally jointed to the floor 15, namely by a sealing spray of the same polyurea referred to above. The sprayed-in joints 19 are strong, insect-proof and waterproof. In some embodiments the joints are made before spraying the skin to the foam core, and in other embodiments they are made after the skin has been sprayed onto the core.

As indicated above, the polyurethane core shrinks a little as it sets and this helps to avoid it undesirably sticking to the steel mould 1. In this regard the side walls 12 can shrink in their height and length dimensions seeing as the lower edge of each is free while on the mould 1. FIG. 7 indicates the direction of shrinking in the height dimension, and FIG. 8 in the length dimension. The rear-end wall 14 is only free to shrink in the height dimension when on the mould 1.

Some benefits of the building of the preferred embodiment are:
the rear-end wall 14, side walls 12 and roof 8 are integral, having been formed in on piece;
the arch shape of the side walls and roof help with release from the mould 1;
the position of the frontend wall 9 can be set to end use requirements;
two of the buildings can be joined end to end to provide a larger construction, and in that event the forward building is moulded so as not to have a rear-end wall;
it has a width of 3 m or less, making it readily transportable on a truck;
the building can be given wheels to facilitate movement from one place to another;
it is relatively lightweight;
it has substantial strength and rigidity;
it provides a high level of thermal insulation;
the thickness of all the walls and the roof can be readily customised during spray-forming to suit end use requirements; and
the shape of the building helps it resist high winds, snow loads and earthquake.

As shown in FIG. 3, the building is reasonably elongate, to provide floor space of about 10 m². It is preferably no more than 3 m wide to make it easier to freight, and most preferably no more than 2.4 m wide. However, in other embodiments it may be larger or smaller. In still further embodiments the building may be made substantially as above, but with the side, frontend and rear-end walls all having the same, or about the same, dimensions. FIG. 9 illustrates the main steel mould 20 used for forming such an item.

While some preferred embodiments of the invention have been described by way of example, it should be appreciated that modifications and improvements can occur without departing from the scope of the following claims.

1. A method of forming a building, comprising the steps of:
obtaining a mould comprising an end wall, a pair of side walls and an open front;
spraying a first spray material onto the outside of the mould so that it sets generally in the shape of the mould to provide a core having at least:
side walls;
an end wall integral with the side walls; and
a roof integral with both the side walls and end wall; and
spraying a second spray material different to the first spray material and comprising polyurea onto the inner and outer surfaces of the core to give it a rigid structural skin.

2. A method according to claim 1, wherein the first spray material sets on the mould as a rigid foam.

3. A method according to 2, wherein the core is 50 mm to 110 mm thick.

4. A method according to claim 2, wherein the core is 70 mm to 100 mm thick.

5. A method according to claim 1, wherein the core is approximately 80 mm thick.

6. A method according to claim 3, wherein the skin is 1 mm to 10 mm thick.

7. A method according to claim 3, wherein the skin is 3 mm to 8 mm thick.

8. A method according to claim 3, wherein the skin is no more than 6 mm thick.

9. A method according to claim 3, wherein the skin is about 3 mm thick.

10. A method according to claim 3, wherein the core comprises polyurethane.

11. A method according to claim 1, wherein the core comprises polyurethane spray foam insulation.

12. A method according to claim 11, wherein the skin comprises polyurea spray lining.

13. A method according to claim 11, wherein the skin comprises isocyanate and polyol.

14. A method according to claim 3 wherein the side walls and roof together give the building an arch shape in transverse cross-section.

15. A method according to claim 14, wherein a further end wall is combined with the side walls at an opposite end to form an enclosed area, this further end wall having a doorway.

16. A method according to claim 15, wherein the side walls and the end walls are secured to a floor.

17. A method according to claim 16, wherein the side walls are securely fixed to the further end wall by spraying a suitable spray material where they meet.

18. A method according to claim 17, wherein the side walls and end walls are securely fixed to a floor by spraying polyurea where they meet the floor.

19. A method according to claim 3, wherein the mould on which the core is sprayed is metallic.

20. A method according to claim 3, wherein the mould on which the core is sprayed is rigid.

21. A building formed by way of a method according to claim 20.

22. A building according to claim 21, wherein at least the end wall and side walls have no internal or external reinforcing.

23. A method according to claim 1, wherein the first spray material sets on the mould as a rigid foam.

24. A method according to claim 1, wherein:
a) the core is 70 mm to 10 mm thick;
b) the skin is no more than 6 mm thick;
c) the core comprises polyurethane;
d) the skin comprises polyurea spray lining or the skin comprises isocyanate and polyol;
e) the side walls and roof together give the building an arch shape in transverse cross-section.
f) a further end wall is combined with the side walls at an opposite end to form an enclosed area, this further end wall having a doorway.
g) the side walls and the end walls are secured to a floor;
h) the side walls are securely fixed to the further end wall by spraying a suitable spray material where they meet;
i) the side walls and end walls are securely fixed to a floor by spraying polyurea where they meet the floor;
j) the mould on which the core is sprayed is rigid metallic; and
k) at least the end wall and side walls have no internal or external reinforcing.
